(19) United States
(12) Patent Application Publication
(10) Pub. No.: US 2025/0114977 A1
(43) Pub. Date: Apr. 10, 2025

(54) START-UP METHOD OF RESIN PELLET PRODUCTION DEVICE, PRODUCTION METHOD OF RESIN PELLETS, AND RESIN PELLET PRODUCTION DEVICE

(71) Applicant: KABUSHIKI KAISHA KOBE SEIKO SHO (KOBE STEEL, LTD.), Hyogo (JP)

(72) Inventors: Kenji TANAKA, Hyogo (JP); Tomonori MURAKAMI, Hyogo (JP); Atsushi MORINAGA, Hyogo (JP)

(73) Assignee: KABUSHIKI KAISHA KOBE SEIKO SHO (KOBE STEEL, LTD.), Hyogo (JP)

(21) Appl. No.: 18/908,720

(22) Filed: Oct. 7, 2024

(30) Foreign Application Priority Data
Oct. 10, 2023 (JP) 2023-175495

(51) Int. Cl. B29B 9/06

(52) U.S. Cl. CPC B29B 9/065

(57) ABSTRACT

The present invention is to reduce a disposal amount of pellet cooling water. A start-up method of a pellet production device includes a water supply step of supplying pellet cooling/transport water stored in a water tank to a water chamber by a pump and filling the water chamber before starting production of resin pellets, and then stopping supply of the pellet cooling/transport water so that a water surface of the pellet cooling/transport water becomes a target water level set to a position lower than an upper end portion of a return path.

### BACKGROUND OF THE INVENTION

### Field of the Invention

The present invention relates to a start-up method of a resin pellet production device, a production method of resin pellets, and a resin pellet production device.

### Description of the Related Art

Conventionally, a pellet production device that produces resin pellets is known. For example, JP 2011-240494 A discloses a granulation device (pellet production device) including a pellet cooling/transport water (PCW) tank (water tank), an outward path, a circulation box (water chamber), and a return path. In this technology, a circulation flow passage in which pellet cooling/transport water (pellet cooling water) flowing from the PCW tank to the circulation box through the outward path flows from the circulation box to the PCW tank through the return path is formed. The return path goes through the upper side of the circulation box and connects the circulation box and the PCW. The granulation device further includes a die (die plate) having die holes arranged facing the water chamber, and a cutter blade (cutter) arranged in the circulation box, the cutter blade that cuts molten resin discharged from the die holes and produces the resin pellets.

In this granulation device, before starting production of the resin pellets, a heat medium flows through an interior of the die and the die is heated. In this state, after circulation of the pellet cooling/transport water in the circulation flow passage, the circulation is stopped, the pellet cooling/transport water is discharged from the circulation box, and a predetermined amount of the pellet cooling/transport water is stored in the circulation box. Then, heat is exchanged between the pellet cooling/transport water stored in the circulation box and the die, and the pellet cooling/transport water is warmed up.

In the technology described in JP 2011-240494 A, in order to lower a water level of the pellet cooling/transport water, the pellet cooling/transport water is discharged from the circulation box to an exterior of the circulation flow passage. Thus, it is not economical. In detail, in the granulation device described above, by stopping the circulation after the circulation of the pellet cooling/transport water, the circulation box is filled with the pellet cooling/transport water. However, at the time point when the circulation is stopped, the pellet cooling/transport water is stored up to an upper end portion of the outward path, and the water level of the pellet cooling/transport water is high. Due to this high water level, excessive water pressure acts on an interior of the circulation box. Thereby, there is a possibility that resin that exists in an interior of the die holes is pushed back and the pellet cooling/transport water intrudes the interior of the die holes. Therefore, in the granulation device, by discharging the pellet cooling/transport water from the circulation box to the exterior of the circulation flow passage, the water level of the pellet cooling/transport water is lowered. However, in general, the pellet cooling/transport water discharged to the exterior of the circulation flow passage is discarded. Thus, discharging the pellet cooling/transport water to the exterior of the circulation flow passage in order to lower the water level invites an increase in a disposal amount and is not economical.

### BRIEF SUMMARY OF THE INVENTION

The present invention has been made in light of the problem described above, and an object thereof is to reduce a disposal amount of pellet cooling water.

A start-up method of a resin pellet production device according to an aspect of the present invention is a start-up method of a resin pellet production device including a circulation flow passage having an outward path through which pellet cooling water discharged from a water tank by a pump reaches a water chamber and a return path through which the pellet cooling water goes through the upper side of the water chamber and reaches the water tank from the water chamber, a die plate having a plurality of die holes, the die plate being arranged facing the water chamber, and a cutter arranged in the water chamber, the cutter that cuts the molten resin discharged from the plurality of die holes and granulates resin pellets, the resin pellet production device in which the granulated resin pellets are transferred from the water chamber while cooling the resin pellets by the pellet cooling water flowing through the circulation flow passage, the start-up method of the resin pellet production device, including a water supply step of supplying the pellet cooling water stored in the water tank to the water chamber by the pump and filling the water chamber before starting production of the resin pellets, and then stopping supply of the pellet cooling water so that a water surface of the pellet cooling water becomes a target water level set to a position lower than an upper end of the return path.

According to the present configuration, in the water supply step, the supply of the pellet cooling water is stopped corresponding to the target water level. Therefore, by discharging the pellet cooling water after circulating the pellet cooling water in the circulation flow passage, it is possible to reduce the disposal amount of the pellet cooling water in comparison to a case where the water surface of the pellet cooling water is set to the target water level.

In the configuration described above, in the water supply step, the pellet cooling water discharged from the water tank by the pump may be supplied to the water chamber while bringing part of the pellet cooling water back to the water tank.

According to the present configuration, in the water supply step, while part of the pellet cooling water is brought back to the water tank, the remaining pellet cooling water is supplied to the water chamber. Thereby, it is possible to reduce a flow rate of the pellet cooling water flowing into the water chamber in comparison to a case where part of the pellet cooling water is not brought back to the water tank. As a result, a pace of accumulating the pellet cooling water in the water chamber becomes relatively gentle. Thus, the supply of the water is more easily stopped when the water surface of the pellet cooling water corresponds to the target water level.

In the configuration described above, in the water supply step, the pellet cooling water may be supplied to the water chamber through a supplementary flow passage having an inner diameter smaller than an inner diameter of the outward path, the supplementary flow passage being disposed in parallel to at least part of the outward path.

According to the present configuration, in the water supply step, the pellet cooling water is supplied to the water chamber through the supplementary flow passage having the inner diameter smaller than the inner diameter of the outward path. Thus, it is possible to reduce the flow rate of the pellet cooling water flowing into the water chamber in comparison to a case where the water is supplied exclusively through the outward path. As a result, the pace of accumulating the pellet cooling water in the water chamber becomes relatively gentle. Thus, the supply of the water is more easily stopped when the water surface of the pellet cooling water corresponds to the target water level.

In the configuration described above, the start-up method of the resin pellet production device may further include a rotation step to be performed at least after the water supply step, the rotation step of rotating the cutter in a state where the cutter is in contact with the die plate, and in the rotation step, the cutter may be rotated while supplying the pellet cooling water to the water chamber through the supplementary flow passage.

In the rotation step, there is a danger that a temperature of the die plate is excessively increased due to friction heat generated by rotation of the cutter in contact with the die plate. Meanwhile, according to the configuration described above, the pellet cooling water is supplied from the supplementary flow passage. Thus, it is possible to control the temperature of the die plate.

In the configuration described above, in the rotation step, the pellet cooling water may be discharged through a discharge flow passage that provides communication between the water chamber and an exterior of the water chamber while supplying the pellet cooling water to the water chamber.

According to the present configuration, it is possible to agitate the pellet cooling water in the water chamber by the cutter rotated in the water chamber while replacing the pellet cooling water in the water chamber. Thereby, it is possible to suppress local boiling from generating in the water chamber. As a result, a temperature of a surface of the die plate facing the water chamber is uniformly maintained.

Further, according to the configuration described above, it is possible to eject the resin dripped from the die holes of the die plate and skimmed by the cutter to the exterior of the water chamber together with the pellet cooling water discharged from the water chamber.

In the configuration described above, in the rotation step, an amount of the pellet cooling water to be discharged through the discharge flow passage may be adjusted so that a position of the water surface of the pellet cooling water in the water chamber is maintained at the target water level.

According to the present configuration, in the rotation step, it is possible to suppress that the water surface of the pellet cooling water is positioned at a water level departing from the target water level.

In the configuration described above, in the water supply step, by setting a flow passage switching mechanism arranged on the downstream side of the pump in the outward path, the flow passage switching mechanism being switchable between a first state where both the water chamber and the water tank are feeding destinations of the pellet cooling water, a second state where one of the water chamber and the water tank is a feeding destination of the pellet cooling water, and a third state where the other of the water chamber and the water tank is a feeding destination of the pellet cooling water, to the first state, the pellet cooling water may be supplied to the water chamber.

According to the present configuration, in the water supply step, the flow passage switching mechanism is brought into the first state. Thus, while part of the pellet cooling water is brought back to the water tank, the remaining pellet cooling water is supplied to the water chamber. Thereby, it is possible to reduce the flow rate of the pellet cooling water flowing into the water chamber in comparison to a case where part of the pellet cooling water is not brought back to the water tank. Also, when a need to circulate the pellet cooling water arises, the flow passage switching mechanism may be switched to the second state and the feeding destination of the pellet cooling water may be set to the water chamber. Further, in a case where there is a need to switch the feeding destination of the pellet cooling water to the water tank, the flow passage switching mechanism may be switched to the third state. In such a way, by providing the flow passage switching mechanism, the feeding destination of the pellet cooling water is more easily switched in accordance with a purpose.

In the configuration described above, the return path may have an upper portion connection flow passage connected to an upper portion of the water chamber, the upper portion connection flow passage extending toward the upper side, and an inclination flow passage including a lower end portion which is connected to the upper portion connection flow passage, the inclination flow passage being inclined to rise gradually from the lower end portion to the upper end of the return path, and in the water supply step, the target water level may be set to a position lower than the lower end portion.

According to the present configuration, the target water level is set to the position lower than the lower end portion of the inclination flow passage. Thus, it is possible to suppress water pressure acting on an interior of the water chamber in comparison to a case where the target water level is set to a position higher than the lower end portion. Thereby, it is possible to push the resin that exists in an interior of the plurality of die holes of the die plate back and efficiently suppress the pellet cooling water from intruding the interior of the plurality of die holes.

Further, there is no need to discharge the pellet cooling water in the inclination flow passage. Thus, it is possible to reduce the disposal amount of the pellet cooling water.

A production method of resin pellets according to another aspect of the present invention is a production method of resin pellets in a resin pellet production device including a circulation flow passage having an outward path through which pellet cooling water discharged from a water tank by a pump reaches a water chamber and a return path through which the pellet cooling water goes through the upper side of the water chamber and reaches the water tank from the water chamber, the production method of the resin pellets, including a water supply step of supplying the pellet cooling water stored in the water tank to the water chamber before starting production of the resin pellets, a rotation step of rotating a cutter arranged in the water chamber in a state where the cutter is in contact with a die plate having a plurality of die holes facing an interior of the water chamber, a heating step of heating the die plate and melting resin that exists in an interior of the plurality of die holes, a material supply step of supplying a resin material to the die plate from the upstream, a production step of producing the resin pellets by cutting the molten resin discharged from the plurality of die holes of the die plate by the cutter in the water chamber, granulating the resin pellets, and transferring the resin pellets from the water chamber while cooling the resin pellets by the pellet cooling water, and an operation stop step of stopping heating of the die plate in a state where the molten resin exists in the interior of the plurality of die holes and stopping an operation of the resin pellet production device, wherein in the water supply step, after the water chamber is filled with the pellet cooling water, supply of the pellet cooling water is stopped so that a water surface of the pellet cooling water becomes a target water level set to a position lower than an upper end of the return path.

According to the present configuration, in the water supply step, the supply of the pellet cooling water is stopped corresponding to the target water level. Therefore, by discharging the pellet cooling water after circulating the pellet cooling water in the circulation flow passage, it is possible to reduce the disposal amount of the pellet cooling water in comparison to a case where the water surface of the pellet cooling water is set to the target water level.

In the configuration described above, in the rotation step, the water surface of the pellet cooling water may be maintained at the target water level, and the rotation number of the cutter may be set to be smaller than the rotation number of the cutter at the time of the production step.

In a case where a water level of the pellet cooling water is maintained at the target water level, the water pressure acting on the interior of the water chamber is suppressed, but there is a possibility that cavitation is generated following rotation of the cutter. Meanwhile, according to the present configuration, the rotation number of the cutter is set to be smaller than the rotation number of the cutter at the time of the production step. Thus, it is possible to suppress generation of cavitation in comparison to a case where the rotation number of the cutter is set to be the same as or larger than the rotation number of the cutter at the time of the production step.

A resin pellet production device according to still another aspect of the present invention is a resin pellet production device, including a water tank in which pellet cooling water is stored, a water chamber that receives the pellet cooling water from the water tank, an outward path that connects the water tank and the water chamber, a return path that goes through the upper side of the water chamber and connects the water chamber and the water tank, a water supply portion that supplies the pellet cooling water from the water tank to the water chamber through the outward path, a die plate having a plurality of die holes facing an interior of the water chamber, and a cutter arranged in the water chamber, the cutter that granulates resin pellets by cutting the molten resin discharged from the plurality of die holes of the die plate in the water chamber, wherein the water supply portion stops supply of the pellet cooling water when a water surface of the pellet cooling water reaches a target water level set to a position lower than an upper end of the return path before starting production of the resin pellets.

According to the present configuration, the pump stops discharge of the pellet cooling water corresponding to the target water level. Thus, by discharging the pellet cooling water after circulating the pellet cooling water in the circulation flow passage, it is possible to reduce the disposal amount of the pellet cooling water in comparison to a case where the water surface of the pellet cooling water is set to the target water level.

In the configuration described above, the resin pellet production device may further include a first supplementary flow passage having an inner diameter smaller than an inner diameter of the outward path, the first supplementary flow passage through which the pellet cooling water flowing out from the water tank is supplied to the water chamber, a return flow passage that branches from the outward path and connects the outward path and the water tank, and a flow passage switching mechanism that switches a feeding destination of the pellet cooling water, and the first supplementary flow passage may take a region of the outward path between the water tank and the flow passage switching mechanism or a predetermined region of the return flow passage as a starting point, take a region of the outward path between the flow passage switching mechanism and the water chamber or the water chamber as a terminal point, and open at the time of supplying the pellet cooling water to the water chamber before starting the production of the resin pellets.

According to the present configuration, it is possible to supply the water to the water chamber through the first supplementary flow passage having the inner diameter smaller than the inner diameter of the outward path. Thereby, it is possible to reduce the flow rate of the pellet cooling water flowing into the water chamber in comparison to a case where the water is supplied exclusively through the outward path. Therefore, the pace of accumulating the pellet cooling water in the water chamber becomes relatively gentle. Thus, the supply of the water is more easily stopped when the water surface of the pellet cooling water corresponds to the target water level. As a result, it is possible to reduce the disposal amount of the pellet cooling water.

In the configuration described above, the resin pellet production device may further include a second supplementary flow passage having an inner diameter smaller than the inner diameter of the outward path, the second supplementary flow passage being different from the first supplementary flow passage, and the second supplementary flow passage may take a region of the outward path between the water tank and the flow passage switching mechanism or a predetermined region of the return flow passage as a starting point, take a distal end of a rotation shaft of the cutter as a terminal point, and communicate with the interior of the water chamber.

The resin pellets cut by the cutter and granulated are normally transferred to the exterior of the water chamber by the pellet cooling water. However, the resin pellets may sometimes be retained in the vicinity of the distal end of the rotation shaft of the cutter upon receiving an influence of a water flow generated in the water chamber by rotation of the cutter. Meanwhile, according to the present configuration, the distal end of the rotation shaft of the cutter is set to the terminal point of the second supplementary flow passage. Thus, it is possible to discharge the pellet cooling water from the distal end and move the resin pellets retained around the distal end. Thereby, it is possible to transfer the retained resin pellets as normal.

In the configuration described above, the resin pellet production device may further include a discharge flow passage through which the pellet cooling water is discharged from the water chamber to an exterior of the water chamber.

According to the present configuration, it is possible to reduce the disposal amount of pellet cooling water.

### BRIEF DESCRIPTION OF THE DRAWINGS

FIG. 1 is a view showing a schematic configuration of a pellet production device according to an embodiment of the present invention.

FIG. 2 is an enlarged sectional view of a die plate provided in the pellet production device of FIG. 1.

FIG. 3 is flowchart showing a production method of resin pellets according to the embodiment of the present invention.

FIG. 4 is a view showing a flow of pellet cooling water at the time of supplying the water by using a water storage flow passage provided in the pellet production device of FIG. 1.

FIG. 5 is a view showing a flow of the pellet cooling water at the time of supplying the water by using an axis-passing flow passage provided in the pellet production device of FIG. 1.

FIG. 6 is a view showing a schematic configuration of a flow passage switching mechanism according to a first modified embodiment of the present invention.

FIG. 7 is a view showing a schematic configuration of a pellet production device according to a second modified embodiment of the present invention.

FIGS. 8A to 8C are schematic views showing a configuration of a flow passage switching mechanism provided in the pellet production device of FIG. 7: FIG. 8A shows the flow passage switching mechanism in a first state; FIG. 8B shows the flow passage switching mechanism in a second state; and FIG. 8C shows the flow passage switching mechanism in a third state.

### DESCRIPTION OF THE PREFERRED EMBODIMENTS

### <Configuration of Pellet Production Device>

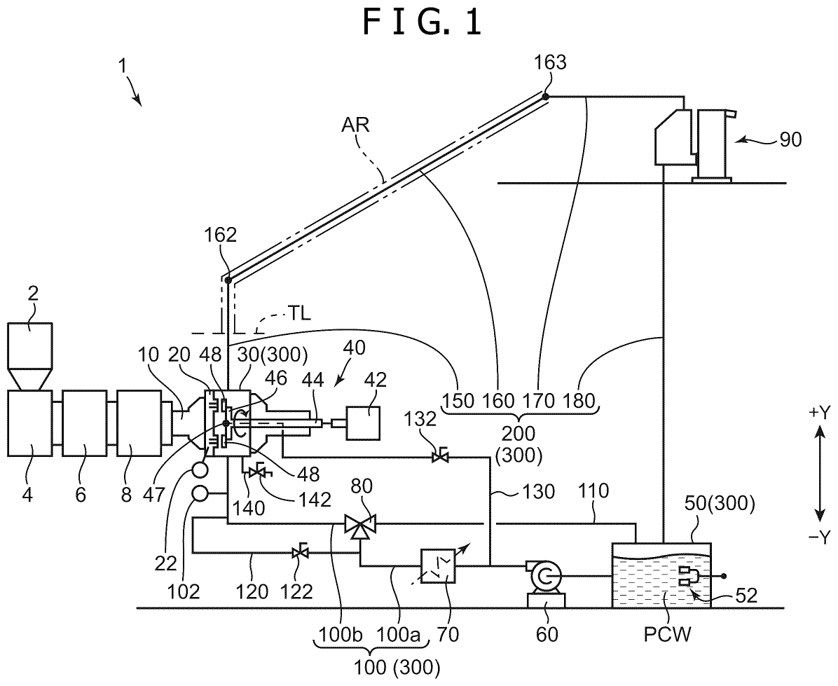

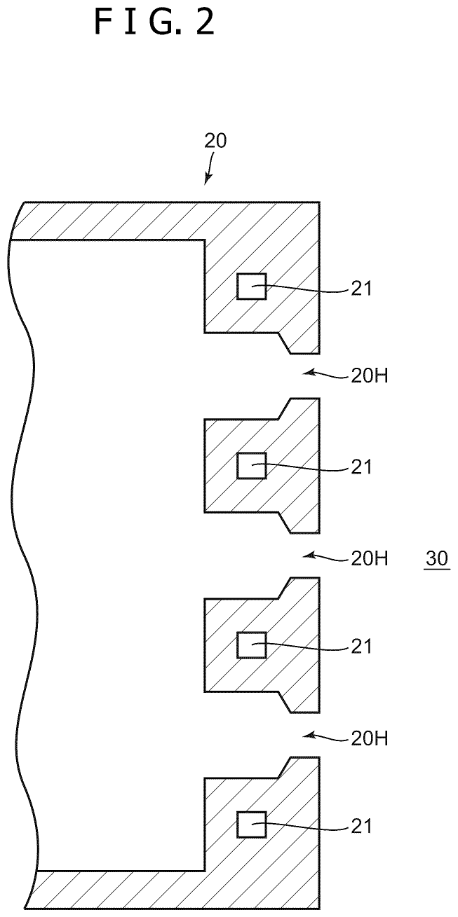

Hereinafter, with reference to the drawings, a pellet production device 1 (resin pellet production device) according to an embodiment of the present invention will be described. FIG. 1 is a view showing a schematic configuration of the pellet production device 1 according to the embodiment of the present invention. FIG. 2 is an enlarged sectional view of a die plate 20 to be described later. It is noted that the +Y direction in the figures will be called as the upward direction, and the-Y direction will be called as the downward direction.

The pellet production device 1 produces resin pellets. As shown in FIG. 1, the pellet production device 1 includes a feeder 2, a mixer 4, a gear pump 6, a screen changer 8, a die holder 10, the die plate 20, a water chamber 30, a pelletizer 40, a water tank 50, a pump 60, a cooling device 70, a flow passage switching mechanism 80, a dryer 90, an outward path 100, a return flow passage 110, a water storage flow passage 120 (first supplementary flow passage), an axis-passing flow passage 130 (second supplementary flow passage), a discharge flow passage 140, and a return path 200.

The feeder 2 supplies a resin material such as polypropylene or polyethylene to the mixer 4.

The mixer 4 is driven by a motor (not shown) and kneads the resin material supplied from the feeder 2. The mixer 4 supplies the kneaded resin material to a diverter valve (not shown). The diverter valve switches a feeding destination of the resin kneaded by the mixer 4. In detail, the diverter valve switches to setting the feeding destination of the resin to the gear pump 6 or to setting the feeding destination of the resin to an exterior of the pellet production device 1.

The gear pump 6 pressurizes the resin material supplied by the diverter valve and feeds the resin material toward the die plate 20. The resin whose pressure is boosted by the gear pump 6 passes through the screen changer 8 and the die holder 10, and reaches the die plate 20.

The screen changer 8 removes foreign substances contained in the resin supplied from the gear pump 6. The resin passing through the screen changer 8 heads to the die plate 20 via the die holder 10.

The die holder 10 holds the die plate 20. In an interior of the die holder 10, a die holder passage (not shown) through which the resin material passing through the screen changer 8 flows is formed.

The die plate 20 is held by the die holder 10 and arranged to oppose the water chamber 30. The die plate 20 has a plurality of die holes 20H facing the water chamber 30 (FIG. 2), a heat medium flow passage 21 (FIG. 2), and a temperature transmitter 22 (FIG. 1). The plurality of die holes 20H provide communication between the die holder passage and an interior of the water chamber 30, and guide the resin material passing through the die holder passage to the interior of the water chamber 30. That is, the resin material passing through the die holder passage and reaching the plurality of die holes 20H are discharged to the water chamber 30 through the plurality of die holes 20H. Each of the die holes 20H is formed to have a small diameter, and thereby, the resin material discharged from each of the die holes 20H is formed to be thin and long. The heat medium flow passage 21 is a flow passage through which a heat medium that heats the die plate 20 flows. As the heat medium, for example, steam, hot oil, etc. is used. The temperature transmitter 22 measures a temperature of the die plate 20. The temperature measured by the temperature transmitter 22 is transmitted to a control device (not shown), etc.

Returning to FIG. 1, the water chamber 30 is a container that receives pellet cooling/transport water PCW (pellet cooling water) from the water tank 50 and stores the pellet cooling/transport water PCW. The pellet cooling/transport water PCW is a liquid that transfers resin pellets produced in the pellet production device 1 while cooling the resin pellets.

The pelletizer 40 cuts the resin material discharged from the die plate 20 and granulates the resin pellets. In detail, the pelletizer 40 has a pelletizer motor 42, a rotation shaft 44, a cutter holder 46, and a plurality of cutters 48.

The pelletizer motor 42 is a drive source that rotates the plurality of cutters 48.

The rotation shaft 44 has one end portion connected to the pelletizer motor 42, and the other end portion 47 (distal end portion) arranged in the water chamber 30, the other end portion to which the cutter holder 46 is attached, and transmits a rotation force generated by the pelletizer motor 42 to the cutter holder 46. The rotation shaft 44 is formed in a tubular shape, and a space of the rotation shaft 44 on the radially inner side communicates with the interior of the water chamber 30. Also, the rotation shaft 44 is connected to a hydraulic unit or a pneumatic unit (not shown), and is capable of going forward and rearward in the axial direction. That is, the rotation shaft 44 is capable of bringing the cutter holder 46 close to and away from the die plate 20.

The cutter holder 46 is attached to the rotation shaft 44 in a state where the cutter holder 46 surrounds the other end portion 47 of the rotation shaft 44 the in circumferential direction. The plurality of cutters 48 are fixed to the cutter holder 46. In detail, the plurality of cutters 48 are arranged on a radially end surface of the cutter holder 46 at equal intervals or unequal intervals along the circumferential direction.

The plurality of cutters 48 extend along the radial direction taking the radial end surface of the cutter holder 46 as a starting point. By the rotation shaft 44 going forward in the axial direction, the plurality of cutters 48 are brought into contact with a surface of the die plate 20. The plurality of cutters 48 are rotated along the circumferential direction of the cutter holder 46 with the rotation shaft 44 as rotation center following drive of the pelletizer motor 42 and rotation of the cutter holder 46.

The water tank 50 is a container that stores the pellet cooling/transport water PCW. The water tank 50 has a heating device 52. The heating device 52 heats the pellet cooling/transport water PCW stored by the water tank 50.

The pump 60 discharges the pellet cooling/transport water PCW stored by the water tank 50 toward the water chamber 30. It is noted that the pump 60 according to the present embodiment does not have a function of adjusting a flow rate of the pellet cooling/transport water PCW. However, in the other embodiments, the pump 60 may have the function.

The cooling device 70 is arranged on the downstream side of the pump 60 and cools the pellet cooling/transport water PCW flowing from the water tank 50 toward the water chamber 30.

The flow passage switching mechanism 80 is a three-way valve arranged on the downstream side of the pump 60 in the outward path 100, the three-way valve having a first port connected to an outward path first portion 100a to be described later, a second port connected to an outward path second portion 100b to be described later, and a third port connected to the return flow passage 110. The flow passage switching mechanism 80 according to the present embodiment is capable of switching a state between a first state and a second state. The first state is a state where the outward path first portion 100a and the outward path second portion 100b are connected and a connection between the outward path first portion 100a and the return flow passage 110 is inhibited. In other words, the first state is a state where the pellet cooling/transport water PCW flowing out from the water tank 50 by a water flow which is generated by the pump 60 is fed to the water chamber 30. The second state is a state where the outward path first portion 100a and the return flow passage 110 are connected and a connection between the outward path first portion 100a and the outward path second portion 100b is inhibited. In other words, the second state is a state where the pellet cooling/transport water PCW flowing out from the water tank 50 is fed exclusively to the water tank 50.

The dryer 90 is arranged on the upper side of the water chamber 30 and dries the resin pellets. The dryer 90 has a separation device (not shown) that separates the resin pellets and foreign substances.

The outward path 100 configures part of a circulation flow passage 300 and connects the water tank 50 and a lower portion of the water chamber 30. An inner diameter of the outward path 100 is set to be approximately 12 inches to 14 inches. The outward path 100 has the outward path first portion 100a arranged between the water tank 50 and the flow passage switching mechanism 80, and the outward path second portion 100b arranged between the flow passage switching mechanism 80 and the water chamber 30. As shown in FIG. 1, a water level gauge 102 that measures a water level of the pellet cooling/transport water PCW is provided in the outward path second portion 100b.

The return flow passage 110 branches from the outward path 100 and connects the outward path 100 and the water tank 50.

The water storage flow passage 120 is disposed in parallel to at least part of the outward path 100. The water storage flow passage 120 has an inner diameter smaller than the inner diameter of the outward path 100. Specifically, the inner diameter of the water storage flow passage 120 is set to be approximately 2 inches to 3 inches. As shown in FIG. 1, the water storage flow passage 120 according to the present embodiment takes a predetermined region of the outward path first portion 100a as a starting point and takes a predetermined region of the outward path second portion 100b as a terminal point. That is, the water storage flow passage 120 has a structure of branching from the outward path first portion 100a and reaching the outward path second portion 100b. A water storage flow passage valve 122 is provided in the water storage flow passage 120. The water storage flow passage valve 122 is an on-off valve switchable between an open state where the water storage flow passage 120 opens and a close state where the water storage flow passage 120 is sealed. In the present embodiment, the water storage flow passage valve 122 functions as a water supply portion that supplies the pellet cooling/transport water PCW from the water tank 50 to the water chamber 30 through the outward path 100.

The axis-passing flow passage 130 is disposed in parallel to at least part of the outward path 100. The axis-passing flow passage 130 has an inner diameter smaller than the inner diameter of the outward path 100. Specifically, the inner diameter of the axis-passing flow passage 130 is set to be approximately 2 inches to 3 inches. The axis-passing flow passage 130 according to the present embodiment goes through an interior of the rotation shaft 44 taking a predetermined region of the outward path first portion 100a as a starting point and communicates with the water chamber 30 taking the other end portion 47 of the rotation shaft 44 as a terminal point. An axis-passing flow passage valve 132 is provided in the axis-passing flow passage 130. The axis-passing flow passage valve 132 is an on-off valve that switches between an open state where the axis-passing flow passage 130 opens and a close state where the axis-passing flow passage 130 is sealed.

The discharge flow passage 140 connects a bottom portion of the water chamber 30 and a discharge tank (not shown) provided in the pellet production device 1. A discharge flow passage valve 142 whose opening degree is adjustable is provided in the discharge flow passage 140. When the discharge flow passage valve 142 is opened, the pellet cooling/transport water PCW stored in the water chamber 30 flows to the discharge tank.

The return path 200 extends to go through the upper side of the water chamber 30 and connects the water chamber 30 and the water tank 50. In detail, the return path 200 has an upper portion connection flow passage 150, an upward inclination flow passage 160 (inclination flow passage), a dryer connection flow passage 170, and a water tank connection flow passage 180.

The upper portion connection flow passage 150 is connected to an upper end of the water chamber 30 and extends upward taking the upper end as a starting point.

The upward inclination flow passage 160 is inclined to rise gradually toward the dryer 90. The upward inclination flow passage 160 has a proximal end portion 162 (lower end portion) connected to the upper portion connection flow passage 150, and an upper end portion 163 (upper end) connected to the dryer connection flow passage 170. As shown in FIG. 1, the upper end portion 163 is positioned on the uppermost side (highest position) of the return path 200. Specifically, the upper end portion 163 is positioned on the upper side from the upper end of the water chamber 30 by 20 meters.

The dryer connection flow passage 170 connects the upper end portion 163 of the upward inclination flow passage 160 and the dryer 90.

The water tank connection flow passage 180 extends to the lower side from the dryer 90 and connects the dryer 90 and the water tank 50.

The water chamber 30, the water tank 50, the outward path 100, and the return path 200 described above configure the circulation flow passage 300. In the circulation flow passage 300, the pellet cooling/transport water PCW discharged from the water tank 50 by the pump 60 reaches the water chamber 30 through the outward path 100, and the pellet cooling/transport water PCW flowing out from the water chamber 30 goes through the upper side of the water chamber 30 through the return path 200 (the upper portion connection flow passage 150, the upward inclination flow passage 160, the dryer connection flow passage 170, and the water tank connection flow passage 180) and reaches the water tank 50.

### <Production Method of Resin Pellets in Resin Pellet Production Device>

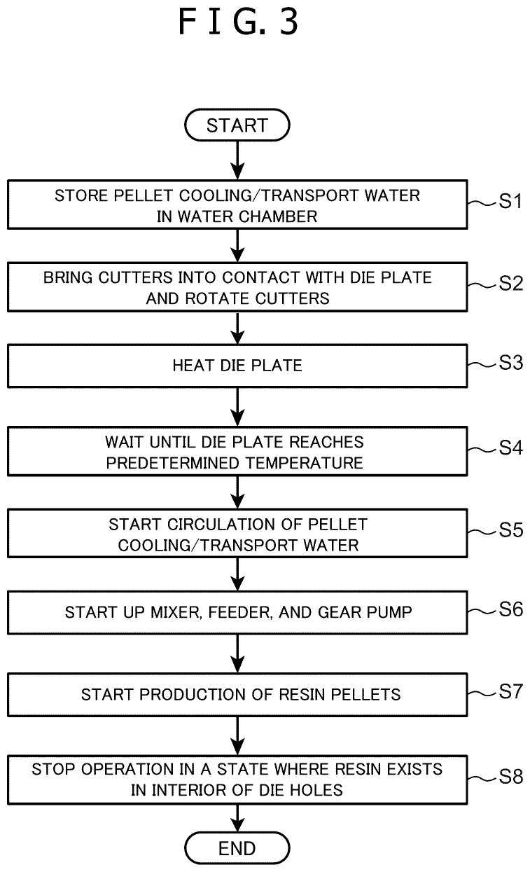

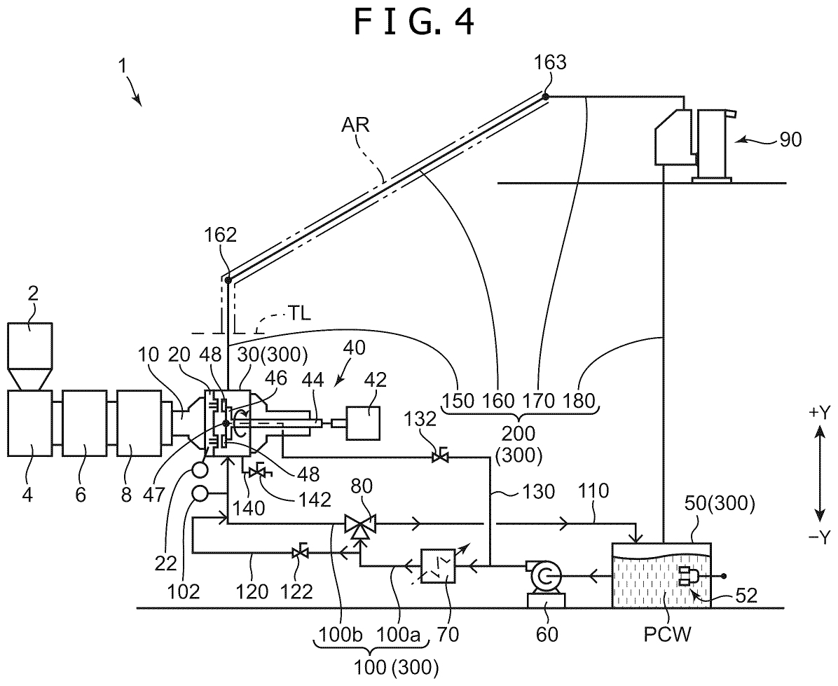

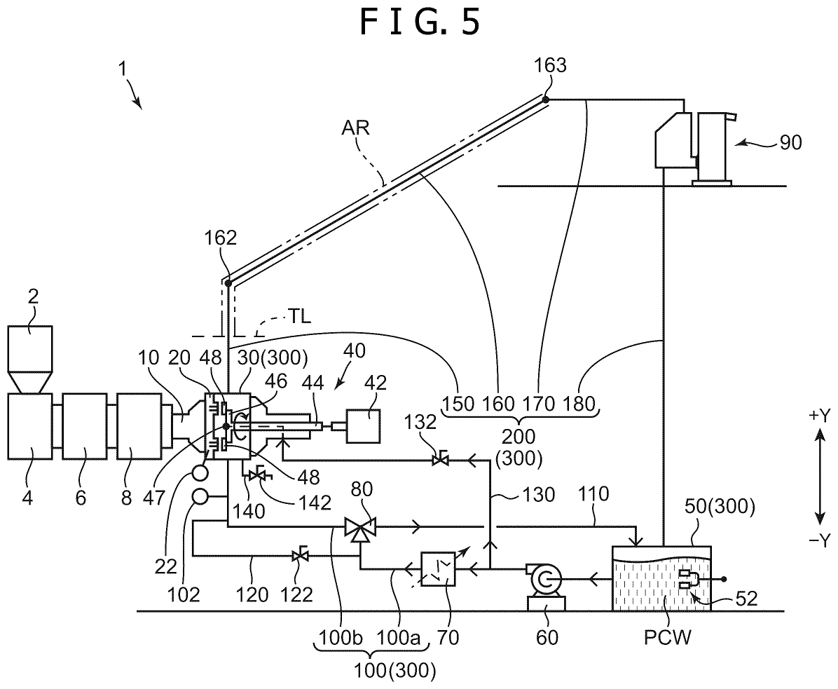

Next, a production method of resin pellets in the pellet production device 1 according to the present embodiment will be described. FIG. 3 is flowchart showing the production method of the resin pellets. FIG. 4 is a view showing a flow of pellet cooling water at the time of supplying the water to the water chamber 30 by using the water storage flow passage 120. FIG. 5 is a view showing a flow of the pellet cooling/transport water PCW at the time of supplying the water to the water chamber 30 by using the axis-passing flow passage 130. It is noted that hereinafter, a situation that solidified resin clogs an interior of the die holes 20H of the die plate 20 after the previous production step (to be described later) is assumed.

With reference to FIG. 3, first, a water supply step of supplying the pellet cooling/transport water PCW stored in the water tank 50 to the blank water chamber 30 is performed (Step S1). In the water supply step, the pellet cooling/transport water PCW is fed to the water chamber 30 by utilizing the water storage flow passage 120. In detail, the flow passage switching mechanism 80 is switched to the second state (state where the outward path first portion 100a and the return flow passage 110 are connected), and the water storage flow passage valve 122 is switched to the open state, so that the water storage flow passage 120 opens. When the pump 60 is started up in this state, as shown in FIG. 4, part of the pellet cooling/transport water PCW discharged from the water tank 50 by the pump 60 flows to the water tank 50 through the return flow passage 110, and the remaining pellet cooling/transport water PCW flows to the water chamber 30 through the water storage flow passage 120.

In the water supply step, the water chamber 30 is filled with the pellet cooling/transport water PCW supplied to the water chamber 30 through the water storage flow passage 120. By referring to a measured value of the water level gauge 102, when a water level (water surface) of the pellet cooling/transport water PCW reaches a target water level TL (FIG. 1) serving as a water level lower than the upper end portion 163 of the upward inclination flow passage 160, the water storage flow passage valve 122 is switched to the close state, SO that supply of the pellet cooling/transport water PCW is stopped.

The target water level TL is a water level lower than the water level of the pellet cooling/transport water PCW when the circulation is stopped after circulating the pellet cooling/transport water PCW. The target water level TL is preferably set to a position (height) at which excessive water pressure is suppressed from acting on the water chamber 30. In detail, the target water level TL is preferably set to a position (height) at which it is possible to suppress generation of water pressure with which the resin material that exists in the plurality of die holes 20H of the die plate 20 is pushed back and the pellet cooling/transport water PCW intrudes the plurality of die holes 20H. As shown in FIG. 1, the target water level TL according to the present embodiment is set to a position higher than an upper portion of the water chamber 30 and lower than the proximal end portion 162 of the upward inclination flow passage 160. That is, the target water level TL is set to an arbitrary region of the upper portion connection flow passage 150.

Next, a rotation step of rotating the plurality of cutters 48 in a state where the cutters 48 are in contact with the die plate 20 is performed (Step S2). First, in the rotation step, the pellet cooling/transport water PCW is supplied to the water chamber 30 through the axis-passing flow passage 130. In detail, the flow passage switching mechanism 80 is set to the second state (state where the outward path first portion 100a and the return flow passage 110 are connected), and the axis-passing flow passage valve 132 is opened, so that the axis-passing flow passage 130 opens. By doing this, as shown in FIG. 5, part of the pellet cooling/transport water PCW flowing out from the water tank 50 flows to the water tank 50 through the return flow passage 110, and the remaining pellet cooling/transport water PCW flows to the water chamber 30 through the axis-passing flow passage 130.

In the rotation step according to the present embodiment, while supplying the pellet cooling/transport water PCW to the water chamber 30, part of the pellet cooling/transport water PCW is discharged through the discharge flow passage 140. In detail, the pellet cooling/transport water PCW is discharged in a state where the opening degree of the discharge flow passage valve 142 is adjusted and the flow rate of the pellet cooling/transport water PCW discharged from the water chamber 30 is adjusted. Thereby, it is possible to maintain a position of the water surface of the pellet cooling/transport water PCW at the target water level TL.

In a state where the supply and discharge of the pellet cooling/transport water PCW are performed, the rotation shaft 44 goes forward in the axial direction, the plurality of cutters 48 are brought into contact with the die plate 20, the pelletizer motor 42 is started up, and the plurality of cutters 48 are rotated. It is noted that the rotation of the plurality of cutters 48 may be started at a time point before the rotation step, for example, a time point of the water supply step.

Also, in the rotation step according to the present embodiment, an output of the pelletizer motor 42 is adjusted so that the rotation number of the plurality of cutters 48 becomes smaller than the rotation number of the plurality of cutters 48 at the time of a production step to be described later.

Next, a heating step of making the heat medium flow through the heat medium flow passage 21 (FIG. 2) of the die plate 20 and heating the die plate 20 is performed (Step S3). In the heating step according to the present embodiment, the pellet cooling/transport water PCW is supplied through the water storage flow passage 120 or the axis-passing flow passage 130, and the pellet cooling/transport water PCW is discharged through the discharge flow passage 140. At this time, the rotation of the plurality of cutters 48 is continuing.

Next, a waiting step of waiting until the die plate 20 reaches a predetermined temperature (temperature at which the resin material that clogs the die holes 20H is melted) is performed (Step S4). As described above, the temperature of the die plate 20 is measured by the temperature transmitter 22. Thus, whether or not the die plate 20 reaches the predetermined temperature is grasped based on a measured value of the temperature transmitter 22.

Next, once the die plate 20 reaches the predetermined temperature, a circulation step of circulating the pellet cooling/transport water PCW is performed (Step S5). In the circulation step, the flow passage switching mechanism 80 is switched to the first state (state where the outward path first portion 100a and the outward path second portion 100b are connected), so that the pellet cooling/transport water PCW is circulated through the circulation flow passage 300.

Next, a start-up step of starting up the mixer 4, the feeder 2, and the gear pump 6 is performed (Step S6). In the start-up step, the resin material newly supplied from the feeder 2, kneaded in the mixer 4, and pressurized by the gear pump 6, the resin material reaching the plurality of die holes 20H pushes the molten resin that exists in the plurality of die holes 20H out to the inside of the water chamber 30. In other words, the start-up step is a step of supplying the resin material from the upstream (upstream in the transfer direction of the resin material) to the die plate 20 (material supply step).

The steps from Step S1 to Step S6 described above correspond to a start-up method of the pellet production device 1.

Next, the production step of producing the resin pellets is performed (Step S7). First, in the production step, the molten resin discharged to the inside of the water chamber 30 is cut by the plurality of cutters 48 and the resin pellets are granulated. At this time, the pellet cooling/transport water PCW is supplied from the axis-passing flow passage 130 so that the resin pellets are not retained in the vicinity of rotation center of the cutters 48 (in the vicinity of the other end portion 47) by a water flow generated in the water chamber 30 by the rotation of the plurality of cutters 48. Next, while cooling the resin pellets by the pellet cooling/transport water PCW stored in the water chamber 30, the resin pellets are transferred to the dryer 90 by the pellet cooling/transport water PCW flowing out from the water chamber 30. After the resin pellets are dried by the dryer 90, the dried resin pellets are discharged to the exterior of the pellet production device 1. Thereby, the resin pellets are produced.

It is noted that the resin pellets produced immediately after start of the production step possibly do not meet the quality as a product. Thus, these resin pellets may be discarded. In this case, the process until the resin pellets are discarded may be regarded to correspond to the start-up method of the pellet production device 1.

Next, when production of the predetermined number of resin pellets is finished in the production step, an operation stop step of stopping an operation of the pellet production device 1 is performed (Step S8). In the operation stop step, running of the mixer, 4, the feeder 2, and the gear pump 6 is stopped, supply of the resin material is stopped, and heating of the die plate 20 is stopped in a state where the molten resin exists in the interior of the plurality of die holes 20H. Until the resin material that clogs the die holes 20H reaches the predetermined temperature (temperature with which the molten material that clogs the die holes 20H is solidified), the pellet production device 1 waits in a state where the pellet cooling/transport water PCW is circulated in the circulation flow passage 300. Thereby, the resin material that clogs the die holes 20H exchanges heat with the circulating pellet cooling/transport water PCW and is solidified in the interior of the die holes 20H. By doing this, it is possible to restart a next operation of the pellet production device 1 from the “situation that the solidified resin clogs the interior of the die holes 20H of the die plate 20” described above. That is, it is possible to restart the next operation from the state of Step S1. After that, the operation of the pellet production device 1 is stopped.

As described above, in the water supply step according to the present embodiment, the supply of the pellet cooling/transport water PCW is stopped corresponding to the target water level TL. Therefore, by discharging the pellet cooling/transport water PCW after circulating the pellet cooling/transport water PCW in the circulation flow passage 300, it is possible to reduce a disposal amount of the pellet cooling/transport water PCW in comparison to a case where the water surface of the pellet cooling/transport water PCW is set to the target water level TL.

Also, in the water supply step according to the embodiment described above, while part of the pellet cooling/transport water PCW is brought back to the water tank 50, the remaining pellet cooling/transport water PCW is supplied to the water chamber 30. Thereby, it is possible to reduce the flow rate of the pellet cooling/transport water PCW flowing into the water chamber 30 in comparison to a case where part of the pellet cooling/transport water PCW is not brought back to the water tank 50. As a result, a pace of accumulating the pellet cooling/transport water PCW in the water chamber 30 becomes relatively gentle. Thus, the supply of the water is more easily stopped when the water surface of the pellet cooling/transport water PCW corresponds to the target water level TL.

In the water supply step according to the embodiment described above, the pellet cooling/transport water PCW is supplied to the water chamber 30 through the water storage flow passage 120 having the inner diameter smaller than the inner diameter of the outward path 100. Thus, the supply of the water is more easily stopped when the water surface of the pellet cooling/transport water PCW corresponds to the target water level TL. In detail, as described above, the outward path 100 (outward path second portion 100b) is set to have the inner diameter approximately from 12 inches to 14 inches. Thus, in a case where the water is supplied by exclusively using the outward path second portion 100b, the pellet cooling/transport water PCW is rapidly accumulated in the water chamber 30. Therefore, in this case, it is difficult to stop the water aiming at the target water level TL. Meanwhile, when the pellet cooling/transport water PCW is supplied through the water storage flow passage 120 having the inner diameter smaller than the inner diameter of the outward path 100 as in the present embodiment, it is possible to reduce the flow rate of the pellet cooling/transport water PCW flowing into the water chamber 30 in comparison to a case where the water is supplied exclusively through the outward path second portion 100b. As a result, the pace of accumulating the pellet cooling/transport water PCW in the water chamber 30 becomes relatively gentle. Thus, in the water supply step, the supply of the water is more easily stopped when water surface of the pellet cooling/transport water PCW corresponds to the target water level TL.

It is noted that in order to reduce the flow rate of the pellet cooling/transport water PCW flowing into the water chamber 30, it can be thought that the pellet production device 1 includes a pump having a function of adjusting the flow rate instead of the pump 60 according to the present embodiment. However, in general, a pump having the function described above is expensive. Thus, there is a danger that such correspondence increases production cost of the pellet production device 1. Meanwhile, in the present embodiment, it is possible to reduce the flow rate of the pellet cooling/transport water PCW without using the expensive pump described above. Thus, it is possible to suppress the production cost from increasing.

Also, in the rotation step according to the embodiment described above, the pellet cooling/transport water PCW is supplied through the axis-passing flow passage 130. Thus, it is possible to control the temperature of the die plate 20. In detail, in the rotation step, there is a danger that the temperature of the die plate 20 is excessively increased due to friction heat generated by the rotation of the plurality of cutters 48 in contact with the die plate 20. Meanwhile, according to the configuration described above, by the pellet cooling/transport water PCW supplied from the axis-passing flow passage 130, it is possible to control the temperature of the die plate 20. That is, it is possible to suppress the temperature of the die plate 20 from increasing excessively.

In particular, in the rotation step according to the embodiment described above, the pellet cooling/transport water PCW is supplied not through the water storage flow passage 120 but through the axis-passing flow passage 130. That is, it is possible to supply the pellet cooling/transport water PCW through the axis-passing flow passage 130 taking the other end portion 47 positioned in the vicinity of the die plate 20 as the terminal point. Thereby, it is possible to supply the pellet cooling/transport water PCW to the vicinity of the die plate 20. Thus, it is possible to more reliably suppress the temperature of the die plate 20 from increasing excessively.

Also, in the rotation step according to the embodiment described above, the pellet cooling/transport water PCW is supplied and discharged while rotating the plurality of cutters 48. That is, it is possible to agitate the pellet cooling/transport water PCW in the water chamber 30 by the plurality of cutters 48 rotated in the water chamber 30 while replacing the pellet cooling/transport water PCW in the water chamber 30. Thereby, it is possible to suppress local boiling from generating in the water chamber 30. As a result, a temperature of the surface of the die plate 20 facing the water chamber 30 is uniformly maintained.

Further, according to the configuration described above, it is possible to eject the resin dripped from the die holes 20H of the die plate 20 and skimmed by the plurality of cutters 48 out to an exterior of the water chamber 30 together with the pellet cooling/transport water PCW discharged from the water chamber 30.

Also, in the rotation step according to the embodiment described above, the flow rate of the pellet cooling/transport water PCW discharged from the discharge flow passage 140 is adjusted so that the position of the water surface of the pellet cooling/transport water PCW is maintained at the target water level TL. Therefore, it is possible to suppress that the water surface of the pellet cooling/transport water PCW is positioned at a water level departing from the target water level TL.

Also, in the water supply step according to the embodiment described above, the target water level TL is set to the position lower than the proximal end portion 162 of the upward inclination flow passage 160. Thus, it is possible to suppress water pressure acting on the interior of the water chamber 30 in comparison to a case where the target water level TL is set to a position higher than the proximal end portion 162. Thereby, it is possible to push the resin material that exists in the interior of the plurality of die holes 20H of the die plate 20 back and efficiently suppress the pellet cooling/transport water PCW from intruding the interior of the die holes 20H.

Further, in the water supply step according to the embodiment described above, there is no need to discharge the pellet cooling/transport water PCW in the upward inclination flow passage 160. Thus, it is possible to reduce the disposal amount of the pellet cooling/transport water PCW. In detail, in a case of adopting a method of setting the water surface of the pellet cooling/transport water PCW to the target water level TL by supplying the water up to the upper end portion 163 of the upward inclination flow passage 160 by circulation of the pellet cooling/transport water PCW, etc., and then discharging the pellet cooling/transport water PCW, the pellet cooling/transport water PCW accumulated in a water immersion region AR shown in FIG. 1 is discharged. Meanwhile, in the water supply step according to the present embodiment, after the interior of the water chamber 30 is filled with the pellet cooling/transport water PCW, the supply of the pellet cooling/transport water PCW is stopped at a time point when the water level of the pellet cooling/transport water PCW corresponds to the target water level TL. By doing this, the water is not accumulated in the water immersion region AR. Thus, there is no need to discharge the pellet cooling/transport water PCW any more. As a result, the disposal amount of the pellet cooling/transport water PCW is reduced.

Also, in the rotation step according to the embodiment described above, the output of the pelletizer motor 42 is adjusted so that the rotation number of the plurality of cutters 48 becomes smaller than the rotation number of the plurality of cutters 48 at the time of the production step. Thus, generation of cavitation is suppressed in the water chamber 30. As described above, in a stage of performing the rotation step, the water level of the pellet cooling/transport water PCW is maintained at the target water level TL, and the water pressure acting on the interior of the water chamber 30 is suppressed. Therefore, if the rotation number of the plurality of cutters 48 at the time of the rotation step is set to be the same as or larger than the rotation number of the plurality of cutters 48 at the time of the production step, there is a possibility that cavitation is generated. Meanwhile, in the present embodiment, the output of the pelletizer motor 42 is adjusted so that the rotation number of the plurality of cutters 48 at the time of the rotation step becomes smaller than the rotation number of the plurality of cutters 48 at the time of the production step. Thus, it is possible to suppress the generation of cavitation.

Also, in the pellet production device 1 according to the embodiment described above, the pump 60 stops the discharge of the pellet cooling/transport water PCW corresponding to the target water level TL. Thus, it is possible to reduce the disposal amount of the pellet cooling/transport water PCW in comparison to a case where the water surface of the pellet cooling/transport water PCW is set to the target water level TL by discharging the pellet cooling/transport water PCW after circulating the pellet cooling/transport water PCW in the circulation flow passage 300.

Also, in the pellet production device 1 according to the embodiment described above, it is possible to supply the water to the water chamber 30 through the water storage flow passage 120 having the inner diameter smaller than the inner diameter of the outward path 100. Thereby, it is possible to reduce the flow rate of the pellet cooling/transport water PCW flowing into the water chamber 30 in comparison to a case where the water is supplied exclusively through the outward path 100. Therefore, the pace of accumulating the pellet cooling/transport water PCW in the water chamber 30 becomes relatively gentle. Thus, the supply of the water is more easily stopped when the water surface of the pellet cooling water corresponds to the target water level TL. As a result, it is possible to reduce the disposal amount of the pellet cooling/transport water PCW.

Also, in the pellet production device 1 according to the embodiment described above, the terminal point of the axis-passing flow passage 130 is set to the other end portion 47, that is, the distal end of the rotation shaft 44. Thus, it is possible to transfer the resin pellets retained in the vicinity of the other end portion 47 as normal. In detail, the resin pellets cut by the plurality of cutters 48 and granulated are normally transferred to the exterior of the water chamber 30 by the pellet cooling/transport water PCW. However, the resin pellets may sometimes be retained in the vicinity of the other end portion 47 upon receiving an influence of the water flow generated in the water chamber 30 by the rotation of the plurality of cutters 48. Meanwhile, according to the present configuration, the terminal point of the axis-passing flow passage 130 is set to the other end portion 47. Thus, it is possible to discharge the pellet cooling water from the other end portion 47 and move the resin pellets retained around the other end portion 47. Thereby, it is possible to transfer the resin pellets retained in the vicinity of the other end portion 47 as normal.

Also, the pellet production device 1 according to the embodiment described above includes the discharge flow passage 140. Thus, it is possible to discharge the pellet cooling/transport water PCW.

Further, In the heating step according to the present embodiment, the pellet cooling/transport water PCW is supplied through the water storage flow passage 120 or the axis-passing flow passage 130, and the pellet cooling/transport water PCW is discharged through the discharge flow passage 140. That is, the pellet cooling/transport water PCW in the water chamber 30 is appropriately replaced. According to this configuration, it is possible to suppress the water temperature of the pellet cooling/transport water PCW in the water chamber 30 from increasing excessively.

Further, in the heating step according to the present embodiment, the plurality of cutters 48 are rotated. According to this configuration, the pellet cooling/transport water PCW stored in the water chamber 30 is agitated by the rotation of the plurality of cutters 48 and the water temperature in the water chamber 30 is uniformized. Therefore, it is possible to uniformly warm up the die plate 20.

Further, in the start-up method of the pellet production device 1 according to the embodiment described above, there is no need to discharge the pellet cooling/transport water PCW unlike a case where the water surface of the pellet cooling/transport water PCW is set to the target water level TL by discharging the pellet cooling/transport water PCW after circulating the pellet cooling/transport water PCW in the circulation flow passage 300. Therefore, it is possible to relatively rapidly start up the pellet production device 1.

Hereinafter, the pellet production device 1 according to the embodiment of the present invention has been described. It is noted that the present invention is not limited to the embodiment described above. The following modified embodiments can be implemented in the present invention.

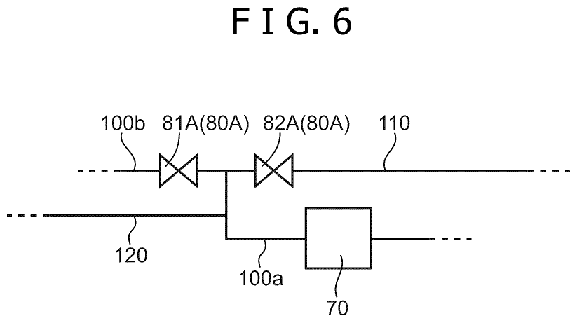

(1) In the previous embodiment, the example in which the flow passage switching mechanism 80 is the three-way valve is described. However, instead of this, the flow passage switching mechanism may be configured by two on-off valves. FIG. 6 is a view showing a schematic configuration of a flow passage switching mechanism 80A according to a first modified embodiment. As shown in FIG. 6, the flow passage switching mechanism 80A according to the present modified embodiment has a first on-off valve 81A and a second on-off valve 82A. The first on-off valve 81A is an on-off valve that switches between an open state where the outward path first portion 100a and the outward path second portion 100b communicate with each other and a close state where both the portions 100a and 100b are blocked from each other. The second on-off valve 82A is an on-off valve that switches between an open state where the return flow passage 110 opens and a close state where the return flow passage 110 is sealed. For example, by bringing the first on-off valve 81A into the open state and bringing the second on-off valve 82A into the close state, it is possible to realize a water flow similar to the first state according to the flow passage switching mechanism 80 of the previous embodiment. Also, by bringing the first on-off valve 81A into the close state and bringing the second on-off valve 82A into the open state, it is possible to realize a water flow similar to the second state of the flow passage switching mechanism 80 according to the previous embodiment. Also, by bringing the first on-off valve 81A into the open state and bringing the second on-off valve 82A into the open state, it is possible to make both the water chamber 30 and the water tank 50 feeding destinations of the pellet cooling/transport water PCW.

(2) In the previous embodiment, the example in which the pellet production device 1 includes the water storage flow passage 120 is described. However, the water storage flow passage 120 is not essential. Hereinafter, a specific description will be given.

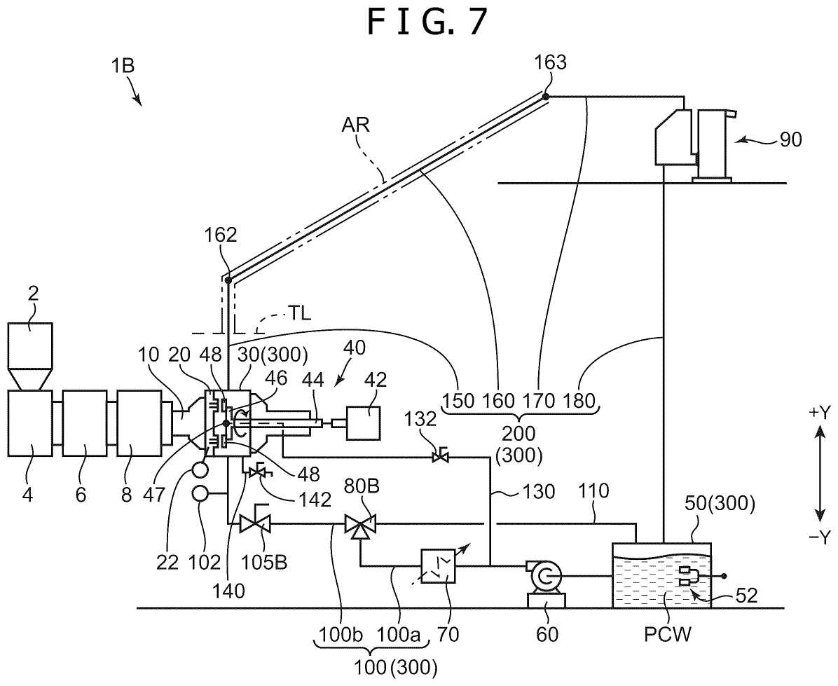

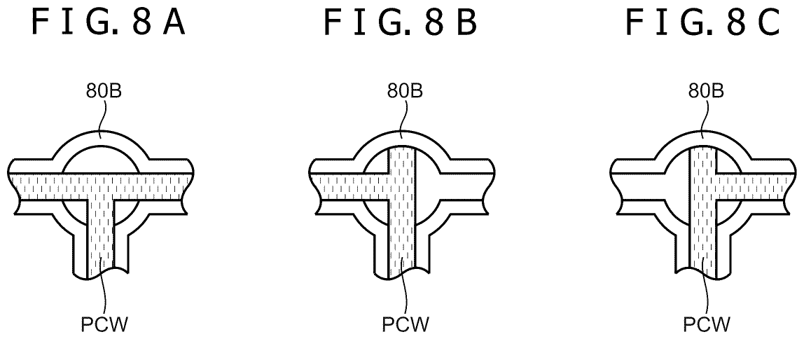

FIG. 7 is a development view of a pellet production device 1B according to a second modified embodiment. FIGS. 8A to 8C are schematic views showing a configuration of a flow passage switching mechanism 80B according to the present modified embodiment. FIG. 8A shows the flow passage switching mechanism 80B in a first state, FIG. 8B shows the flow passage switching mechanism 80B in a second state, and FIG. 8C shows the flow passage switching mechanism 80B in a third state. It is noted that in the present modified embodiment, different points from the embodiment described above will be mainly described, and a description of common points will be omitted.

As shown in FIG. 7, the pellet production device 1B does not include the water storage flow passage 120 unlike the pellet production device 1 according to the previous embodiment. Also, the pellet production device 1B includes the flow passage switching mechanism 80B instead of the flow passage switching mechanism 80 according to the previous embodiment.

The flow passage switching mechanism 80B is a three-way valve arranged on the downstream side of the pump 60 in the outward path 100, the three-way valve having a first port connected to the outward path first portion 100a, a second port connected to the outward path second portion 100b, and a third port connected to the return flow passage 110. As shown in FIGS. 8A to 8C, the flow passage switching mechanism 80B is capable of switching a state between a first state, a second state, and a third state. The first state according to the present modified embodiment (FIG. 8A) is a state where the outward path first portion 100a is connected to both the outward path second portion 100b and the return flow passage 110. In other words, the first state is a state where both the water chamber 30 and the water tank 50 become the feeding destinations of the pellet cooling/transport water PCW. The second state according to the present modified embodiment (FIG. 8B) is a state where a connection between the outward path first portion 100a and the return flow passage 110 is inhibited while connecting the outward path first portion 100a and the outward path second portion 100b. In other words, the second state is a state where the water chamber 30 becomes the feeding destination of the pellet cooling/transport water PCW. The third state according to the present modified embodiment (FIG. 8C) is a state where a connection between the outward path first portion 100a and the outward path second portion 100b is inhibited while connecting the outward path first portion 100a and the return flow passage 110. In other words, the third state is a state where the water tank 50 exclusively becomes the feeding destination of the pellet cooling/transport water PCW.

In a water supply step according to this pellet production device 1B, the pellet cooling/transport water PCW is supplied to the water chamber 30 by closing the axis-passing flow passage valve 132 while bringing the flow passage switching mechanism 80B into the first state.

Also, in a rotation step according to this pellet production device 1B, the pellet cooling/transport water PCW is supplied to the water chamber 30 through the axis-passing flow passage 130 by bringing the flow passage switching mechanism 80B into the third state and opening the axis-passing flow passage valve 132 so that the axis-passing flow passage 130 opens.

Further, as shown in FIG. 7, a flow rate adjustment valve 105B serving as a valve whose opening degree is adjustable is provided in the outward path first portion 100a of the pellet production device 1B. It is possible to reduce the flow rate of the pellet cooling/transport water PCW flowing into the water chamber 30 by decreasing the opening degree of the flow rate adjustment valve 105B.

As described above, in the water supply step of the pellet production device 1B according to the present modified embodiment, the flow passage switching mechanism 80B is set to the first state (state where the outward path first portion 100a is connected to both the outward path second portion 100b and the return flow passage 110). Thus, while part of the pellet cooling/transport water PCW is brought back to the water tank 50, the remaining pellet cooling/transport water PCW is supplied to the water chamber 30. Thereby, it is possible to reduce the flow rate of the pellet cooling/transport water PCW flowing into the water chamber 30 in comparison to a case where part of the pellet cooling/transport water PCW is not brought back to the water tank 50. As a result, the pace of accumulating the pellet cooling/transport water PCW in the water chamber 30 becomes relatively gentle. Thus, the supply of the water is more easily stopped corresponding to the target water level TL. That is, in the water supply step, without using the water storage flow passage 120 or the axis-passing flow passage 130 according to the previous embodiment, it is possible to realize similar effects to a case where the pellet cooling/transport water PCW is supplied to the water chamber 30 by using the water storage flow passage 120 or the axis-passing flow passage 130 according to the previous embodiment. Also, when a need to circulate pellet cooling/transport water PCW arises in the circulation step, etc., the flow passage switching mechanism 80B may be switched to the second state (state where the outward path first portion 100a and the outward path second portion 100b are connected), and the feeding destination of the pellet cooling/transport water PCW may be set to the water chamber 30.

Also, in a case where there is a need to switch the feeding destination of the pellet cooling/transport water PCW to the water tank 50, for example, when the water is supplied through the axis-passing flow passage 130, etc., the flow passage switching mechanism 80B may be set to the third state (state where the outward path first portion 100a and the return flow passage 110 are connected).

In such a way, the pellet production device 1B according to the present modified embodiment includes the flow passage switching mechanism 80B instead of the flow passage switching mechanism 80 according to the previous embodiment. Thus, it is possible to easily switch the feeding destination of the pellet cooling/transport water PCW in accordance with a purpose.

Further, the pellet production device 1B according to the present modified embodiment includes the flow rate adjustment valve 105B serving as a valve whose opening degree is adjustable. Therefore, for example, in a case where the flow passage switching mechanism 80B is set to the first state, it is possible to further reduce the flow rate of the pellet cooling/transport water PCW supplied to the water chamber 30 by setting the opening degree of the flow rate adjustment valve 105B to be small. As a result, the pace of accumulating the pellet cooling/transport water PCW in the water chamber 30 becomes further gentle. Thus, the supply of the water is furthermore easily stopped when the water surface of the pellet cooling/transport water PCW corresponds to the target water level TL.

(3) In the previous embodiment, the example in which the pellet cooling/transport water PCW is supplied to the water chamber 30 through the water storage flow passage 120 in the water supply step is described. However, instead of this, the pellet cooling/transport water PCW may be supplied through the axis-passing flow passage 130. In other words, the axis-passing flow passage valve 132 of the axis-passing flow passage 130 may function as the water supply portion according to the present invention. Alternatively, in the water supply step, the pellet cooling/transport water PCW may be supplied to the water chamber 30 by utilizing both the water storage flow passage 120 and the axis-passing flow passage 130. That is, the water storage flow passage valve 122 of the water storage flow passage 120 and the axis-passing flow passage valve 132 of the axis-passing flow passage 130 may function as the water supply portion according to the present invention.

(4) In the previous embodiment, the water storage flow passage 120 taking the predetermined region of the outward path first portion 100a as the starting point and taking the predetermined region of the outward path second portion 100b as the terminal point is described. However, the starting point and the terminal point of the water storage flow passage 120 are not limited to this. Although not illustrated in the figures, the water storage flow passage 120 may take a predetermined region of the return flow passage 110 as a starting point. Also, although not illustrated in the figures, the water chamber 30 may be taken as a terminal point.

(5) In the previous embodiment, the axis-passing flow passage 130 taking the predetermined region of the outward path first portion 100a as the starting point and taking the other end portion 47 of the rotation shaft 44 as the terminal point is described. However, the starting point of the axis-passing flow passage 130 is not limited to this. Although not illustrated in the figures, the axis-passing flow passage 130 may take an arbitrary region of the return flow passage 110 as a starting point.

(6) The pellet production device 1 according to the previous embodiment may further include a water amount adjusting flow passage taking the upper portion of the water chamber 30 or a region of the upper portion connection flow passage 150 lower than the target water level TL as a starting point and taking the discharge tank (not shown) as a terminal point.

(7) In the previous embodiment, the example in which the water storage flow passage valve 122 functions as the water supply portion according to the present invention is described. However, instead of this, the pump 60 may function as the water supply portion. In this case, stop of the supply of the water in the water supply step may be realized by stopping an operation of the pump 60. It is noted that the operation of the pump 60 may be stopped manually, or the control device (not shown) provided in the pellet production device 1 may stop the operation automatically.

What is claimed is:

1. A start-up method of a resin pellet production device comprising:
a circulation flow passage having an outward path through which pellet cooling water discharged from a water tank by a pump reaches a water chamber and a return path through which the pellet cooling water goes through the upper side of the water chamber and reaches the water tank from the water chamber;
a die plate having a plurality of die holes, the die plate being arranged facing the water chamber; and
a cutter arranged in the water chamber, the cutter that cuts molten resin discharged from the plurality of die holes and granulates resin pellets,
the resin pellet production device in which the granulated resin pellets are transferred from the water chamber while cooling the resin pellets by the pellet cooling water flowing through the circulation flow passage,
the start-up method of the resin pellet production device, comprising:
a water supply step of supplying the pellet cooling water stored in the water tank to the water chamber by the pump and filling the water chamber before starting production of the resin pellets, and then stopping supply of the pellet cooling water so that a water surface of the pellet cooling water becomes a target water level set to a position lower than an upper end of the return path.

2. The start-up method of the resin pellet production device according to claim 1,
wherein in the water supply step, the pellet cooling water discharged from the water tank by the pump is supplied to the water chamber while bringing part of the pellet cooling water back to the water tank.

3. The start-up method of the resin pellet production device according to claim 1,
wherein in the water supply step, the pellet cooling water is supplied to the water chamber through a supplementary flow passage having an inner diameter smaller than an inner diameter of the outward path, the supplementary flow passage being disposed in parallel to at least part of the outward path.

4. The start-up method of the resin pellet production device according to claim 3, further comprising:
a rotation step to be performed at least after the water supply step, the rotation step of rotating the cutter in a state where the cutter is in contact with the die plate,
wherein in the rotation step, the cutter is rotated while supplying the pellet cooling water to the water chamber through the supplementary flow passage.

5. The start-up method of the resin pellet production device according to claim 4,
wherein in the rotation step, the pellet cooling water is discharged through a discharge flow passage that provides communication between the water chamber and an exterior of the water chamber while supplying the pellet cooling water to the water chamber.

6. The start-up method of the resin pellet production device according to claim 5,
wherein in the rotation step, an amount of the pellet cooling water to be discharged through the discharge flow passage is adjusted so that a position of the water surface of the pellet cooling water in the water chamber is maintained at the target water level.

7. The start-up method of the resin pellet production device according to claim 2,
wherein in the water supply step, by setting a flow passage switching mechanism arranged on the downstream side of the pump in the outward path, the flow passage switching mechanism being switchable between a first state where both the water chamber and the water tank are feeding destinations of the pellet cooling water, a second state where one of the water chamber and the water tank is a feeding destination of the pellet cooling water, and a third state where the other of the water chamber and the water tank is a feeding destination of the pellet cooling water, to the first state, the pellet cooling water is supplied to the water chamber.

8. The start-up method of the resin pellet production device according to claim 7,
wherein the return path has an upper portion connection flow passage connected to an upper portion of the water chamber, the upper portion connection flow passage extending toward the upper side, and an inclination flow passage including a lower end portion which is connected to the upper portion connection flow passage, the inclination flow passage being inclined to rise gradually from the lower end portion to the upper end of the return path, and
wherein in the water supply step, the target water level is set to a position lower than the lower end portion.

9. A production method of resin pellets in a resin pellet production device including a circulation flow passage having an outward path through which pellet cooling water discharged from a water tank by a pump reaches a water chamber and a return path through which the pellet cooling water goes through the upper side of the water chamber and reaches the water tank from the water chamber,
the production method of the resin pellets, comprising:
a water supply step of supplying the pellet cooling water stored in the water tank to the water chamber before starting production of the resin pellets;
a rotation step of rotating a cutter arranged in the water chamber in a state where the cutter is in contact with a die plate having a plurality of die holes facing an interior of the water chamber;
a heating step of heating the die plate and melting resin that exists in an interior of the plurality of die holes;
a material supply step of supplying a resin material to the die plate from the upstream;
a production step of producing the resin pellets by cutting the molten resin discharged from the plurality of die holes of the die plate by the cutter in the water chamber, granulating the resin pellets, and transferring the resin pellets from the water chamber while cooling the resin pellets by the pellet cooling water; and
an operation stop step of stopping heating of the die plate in a state where the molten resin exists in the interior of the plurality of die holes and stopping an operation of the resin pellet production device,
wherein in the water supply step, after the water chamber is filled with the pellet cooling water, supply of the pellet cooling water is stopped so that a water surface of the pellet cooling water becomes a target water level set to a position lower than an upper end of the return path.

10. The production method of the resin pellets according to claim 9,
wherein in the rotation step, the water surface of the pellet cooling water is maintained at the target water level, and the rotation number of the cutter is set to be smaller than the rotation number of the cutter at the time of the production step.

11. A resin pellet production device, comprising:
a water tank in which pellet cooling water is stored;
a water chamber that receives the pellet cooling water from the water tank;
an outward path that connects the water tank and the water chamber;
a return path that goes through the upper side of the water chamber and connects the water chamber and the water tank;
a water supply portion that supplies the pellet cooling water from the water tank to the water chamber through the outward path;
a die plate having a plurality of die holes facing an interior of the water chamber; and
a cutter arranged in the water chamber, the cutter that granulates resin pellets by cutting the molten resin discharged from the plurality of die holes of the die plate in the water chamber,
wherein the water supply portion stops supply of the pellet cooling water when a water surface of the pellet cooling water reaches a target water level set to a position lower than an upper end of the return path before starting production of the resin pellets.

12. The resin pellet production device according to claim 11, further comprising:
a first supplementary flow passage having an inner diameter smaller than an inner diameter of the outward path, the first supplementary flow passage through which the pellet cooling water flowing out from the water tank is supplied to the water chamber;
a return flow passage that branches from the outward path and connects the outward path and the water tank; and
a flow passage switching mechanism that switches a feeding destination of the pellet cooling water,
wherein the first supplementary flow passage takes a region of the outward path between the water tank and the flow passage switching mechanism or a predetermined region of the return flow passage as a starting point, takes a region of the outward path between the flow passage switching mechanism and the water chamber or the water chamber as a terminal point, and opens at the time of supplying the pellet cooling water to the water chamber before starting the production of the resin pellets.

13. The resin pellet production device according to claim 12, further comprising:
a second supplementary flow passage having an inner diameter smaller than the inner diameter of the outward path, the second supplementary flow passage being different from the first supplementary flow passage,
wherein the second supplementary flow passage takes a region of the outward path between the water tank and the flow passage switching mechanism or a predetermined region of the return flow passage as a starting point, takes a distal end of a rotation shaft of the cutter as a terminal point, and communicates with the interior of the water chamber.

14. The resin pellet production device according to claim 11, further comprising:
a discharge flow passage through which the pellet cooling water is discharged from the water chamber to an exterior of the water chamber.
